(19) United States
(12) Patent Application Publication
(10) Pub. No.: US 2018/0135329 A1
(43) Pub. Date: May 17, 2018

(54) FLAG POLE HOOK MOUNTING BRACKET

(71) Applicant: Fred Kevin Lillywhite, West Jordan, UT (US)

(72) Inventor: Fred Kevin Lillywhite, West Jordan, UT (US)

(21) Appl. No.: 15/806,334

(22) Filed: Nov. 8, 2017

Related U.S. Application Data
(60) Provisional application No. 62/497,416, filed on Nov. 17, 2016.

(51) Int. Cl. E04H 12/22; E04H 15/60

(52) U.S. Cl. CPC E04H 12/2253; G09F 2017/0066; E04H 15/60

(57) ABSTRACT

A system for rigidly mounting a flag pole or other device to a protruding eye bolt or ring hook attached to a portable shelter. The invention is configured to not interfere with the collapsing action of the shelter. A hand knob is also included to facilitate installing alternate devices to the mounting system.

### CROSS REFERENCE TO RELATED APPLICATION

This application claims the benefit of U.S. Provisional Patent Application Ser. No. 62/497,416 filed Nov. 17, 2016, in the name of FRED KEVIN LILLYWHITE, the disclosure of which is hereby incorporated herein in its entirety by this reference.

### FIELD OF THE INVENTION

The invention is an assembly composed of a locking block containing a hook, various mounting hardware (nuts, bolts, washers), and a pole or device capable of being received by the hook. The invention relates to the attachment of a pole or device on a ring, hook, eye-bolt, or the like which protrudes from a flat or curved surface such as a portable shelter.

### DESCRIPTION OF THE RELATED ART

Portable pop-up shelters are commonly used in outdoor settings to serve as a wind breaker for outdoorsmen. Shelters that utilize the tension of the shelter fabric and the frame poles to pop the shelter open are typically equipped with an eye-bolt or ring hook which protrudes out of the fabric at the intersection of frame poles. This eye-bolt can be used as a hand grip for the outdoorsmen to assist in setting up the shelter and as a tether point for securing the shelter to a stake in the ground or ice with a rope. The eye-bolt on the roof of the shelter is occasionally used in setting up the shelter but is never used as a rope tether point.

When multiple portable shelters are congregated, it can be difficult to identify the outdoorsmen inside a particular shelter without engaging the outdoorsmen inside. In a setting such as ice fishing, it is common for the outdoorsmen to move the portable shelter many times in a day making it even more difficult to engage with the correct shelter. If the outdoorsmen are participating in an ice fishing tournament and the tournament officials require them to display a participation tag, the exterior of these portable shelters usually lacks easy attachment features except for the eye-bolts on the corners. If the participation tag is attached to a side wall eye-bolt, the tag is only visible to tournament officials from a vantage point where they can see that particular wall. The only attachment point visible from any vantage point around the shelter is the roof eye-bolt. If the tag is attached to the roof eye bolt without a structure to elevate the tag, then the tag will only be visible from a vantage point higher than the shelter's roof. Also since the outdoorsmen typically move the shelter to multiple locations, the attachment needs to be able to collapse with the shelter.

Therefore, a need exists for a system which attaches to the shelter roof, collapses with the shelter, and elevates the tag, marker, or flag to be displayed.

### SUMMARY

The invention is a mounting bracket assembly which rigidly couples a flag pole (2) or other device to the exterior of a portable shelter (1). The method the invention uses to couple to the portable shelter (1) does not degrade or otherwise destroy the shelter fabric.

The invention occupies a shape and volume smaller than the open space above the ring hook when the portable shelter (1) is collapsed. This shape and volume allows the invention to remain attached to the portable shelter (1) when the portable shelter is collapsed.

### BRIEF DESCRIPTION OF THE DRAWINGS

FIG. 1 is a perspective view of the invention with a flag installed on the top of a portable shelter.

FIG. 2 is a perspective view of the invention without the portable shelter.

FIG. 3 is an isometric exploded view showing separate components of the invention.

FIG. 4 is an isometric view of the hook in the preferred embodiment.

FIG. 5 is a perspective view of the end portion of the flag pole showing the location of receiving features.

FIG. 6 is an isometric view of the locking block in the preferred embodiment.

FIG. 7 is a perspective view of the invention attached to a section of a collapsed portable shelter.

FIG. 8 is a perspective view of the invention showing alternate devices which could be mounted to the hook.

FIG. 9 is a perspective view of the hook attached to an eye bolt in an alternate embodiment using multiple bodies.

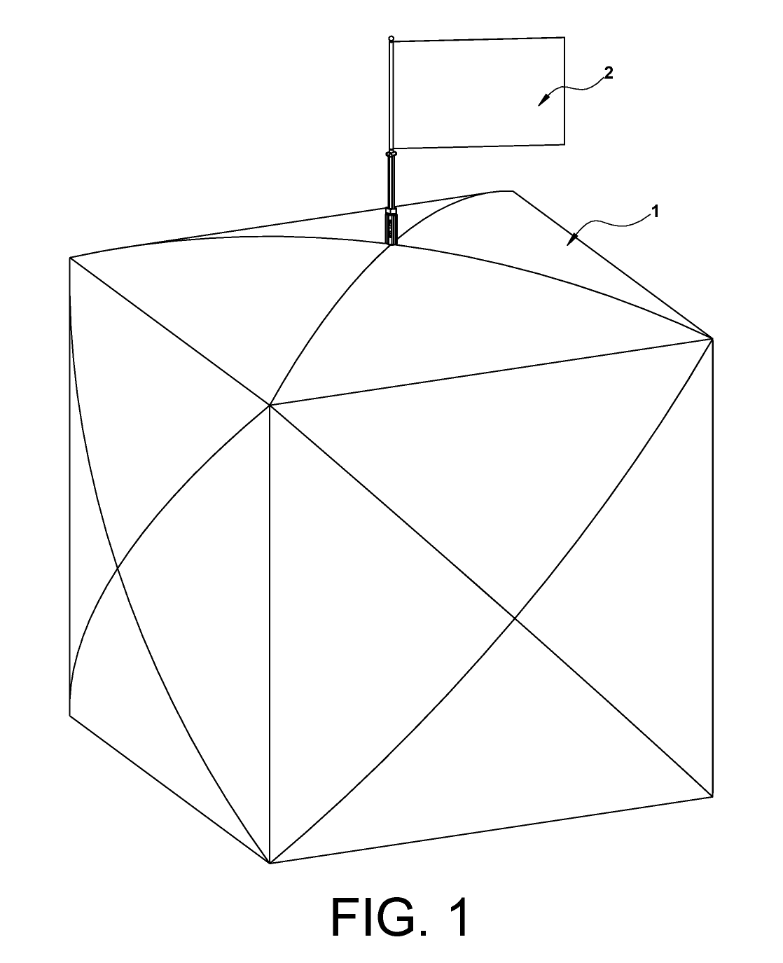

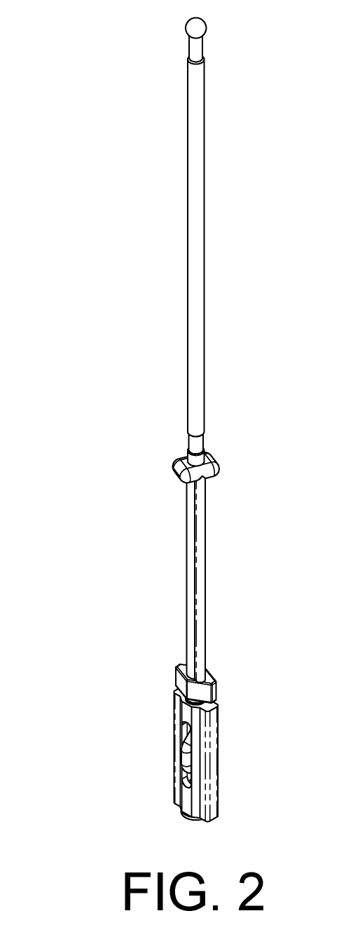

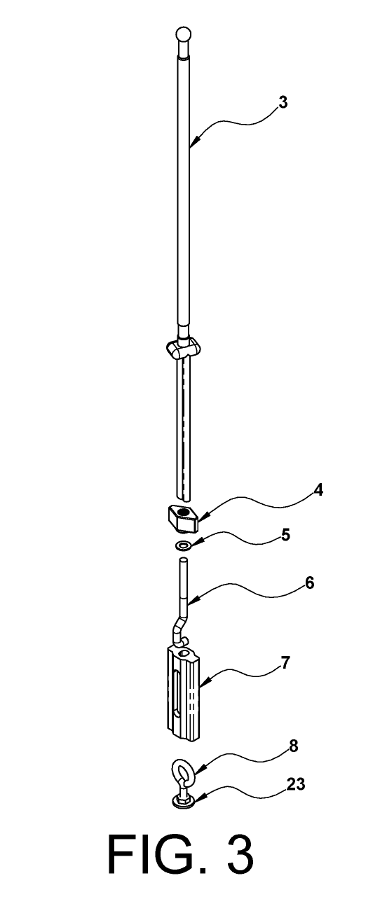

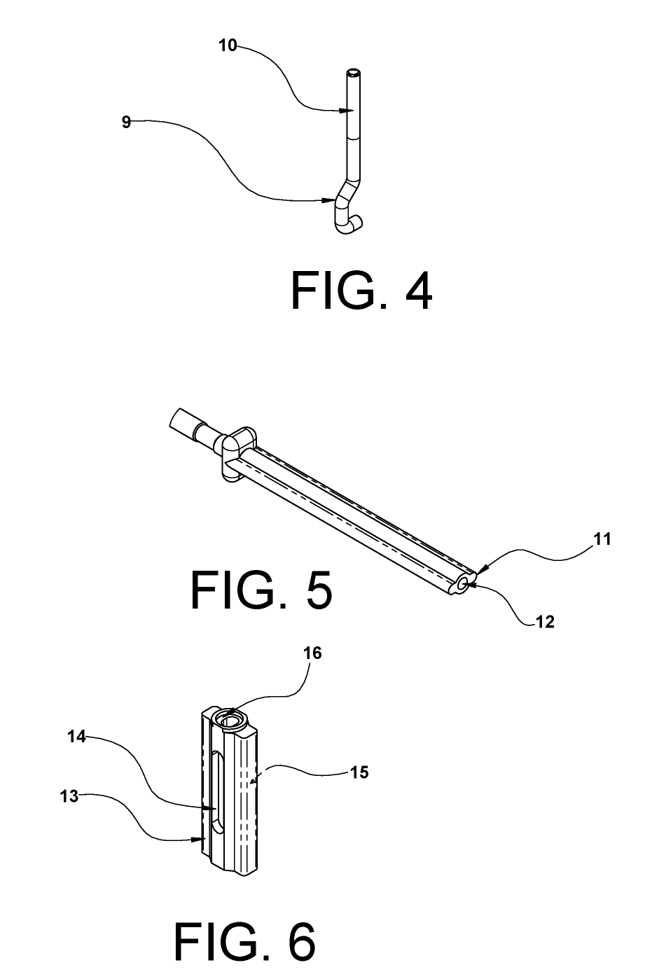

### DETAILED DESCRIPTION

The body of the hook (6) contains a curved profile (9) and may have screw threads, tabs, flanges, contoured surfaces, or the like features on one or more surfaces (10). The features of the hook (6) are a connector for the pole (3).

The pole (3) end surface (11) may contain a hole, tabs, contoured surfaces, screw threads or other like features (12) to allow the pole (3) to receive the features on the hook (6).

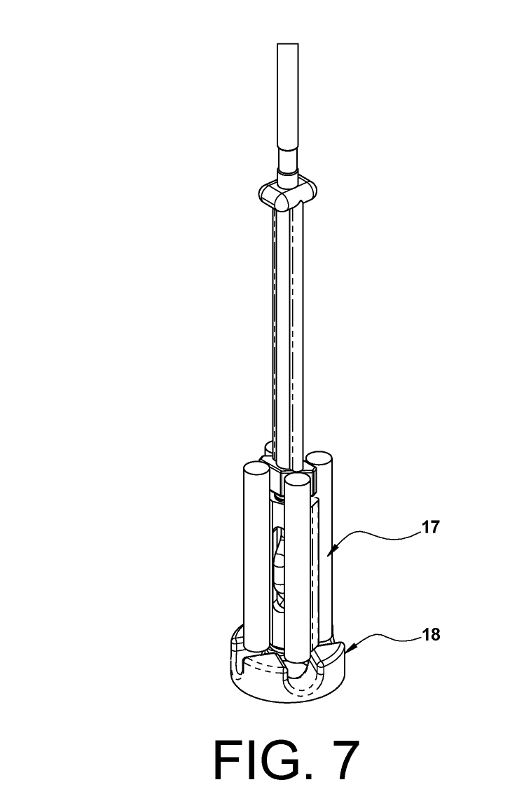

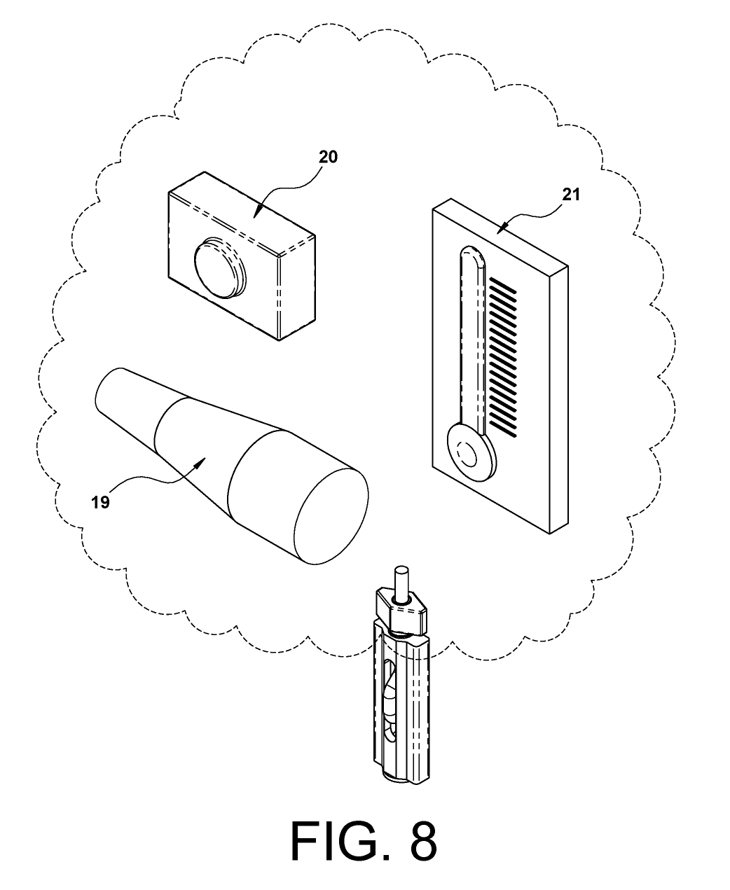

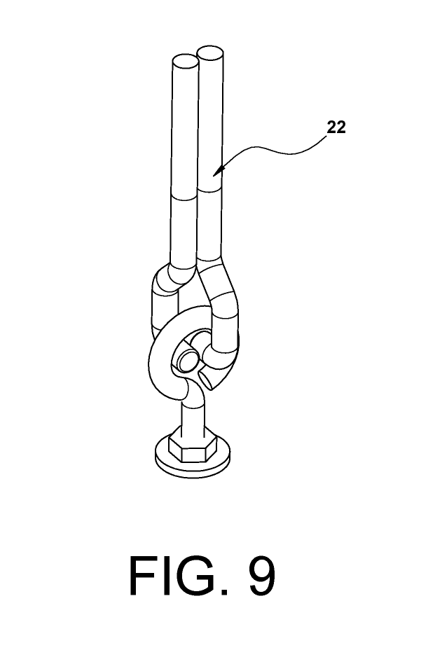

The locking block (7) first side wall (13) may contain an elongated hole (14). The elongated hole in the first side wall allows the hook (6) to exit the locking block (7) during installation. The second side wall (15) of the locking block (7) contains curves, angles, and flat surfaces hereafter referred to as features. The features of the first side wall (13) and second side wall (15) fit inside the open volume of the collapsed shelter directly above the eye bolt (8) or ring hook (FIG. 7). The features' size allows the pole to remain fixed in relation to the shelter frame poles (17) and hub (18) when the shelter is collapsed. The third surface (16) of the locking block (7) contains a hole or elongated hole which is capable of receiving the hook (6). The locking block (7) body is hollow as required to cover the shelter eye bolt (8).

The common single or multi-arm knob (4) contains internal screw threads or locking features which engage the hook (6).

In the preferred embodiment the hook (6) is a single body with a curved profile and the hook (6) end surface (10) is threaded. The locking block (7) elongated hole (14) in the third surface (16) receives the hook (6). The elongated hole (14) in the locking block (7) first side wall allows the hook (6) to pivot slightly in one axis and translate parallel to the locking block (7) first side wall. The pole (3) end surface (11) contains a smooth bore (12) of similar diameter to the hook (6) which extends in the pole (3) primary axis. When the hook (6) is coupled to the shelter eye bolt (10), the threaded hook (6) end surface (10) protrudes out the locking block (7) third surface. A bearing washer (5) or other hardware may be placed between the knob (4) and the locking block (7). The hook (6) screw threads are engaged by the internal screw threads of the multi-arm knob (4). When twisted in the correct direction, the multi-arm knob (4) clamps the locking block (7) onto the shelter eye bolt (8) supporting washer (23) or the shelter fabric.

In another embodiment, the multi-arm knob (4) is used to clamp the locking block (7) to the shelter washer or shelter fabric. The pole (3) may then be screwed or pressed on the hook (6) or replaced by another device which is capable of receiving or attaching to the screw threads (10) on the hook (6). Example devices may include a camera (20), light source, thermometer (21), wind sock (19), or the like.

In yet another embodiment, the pole (3) end surface (11) contains screw threads to match the hook (6) screw threads. The pole (3) screw threads (12) are used to clamp the locking block (7) to the shelter washer or shelter fabric. The pole (3) may then be screwed or pressed on the hook (6).

In still another embodiment, the hook (6) end surface (12) contains tabs. The pole (3) end surface (11) contains a helical winged hole capable of engaging the tabs similar to screw threads. As the pole (3) is twisted in the correct direction the tabs of the hook (6) translate parallel to the pole's primary axis which provides the mechanism to clamp the locking block (7).

In still yet another embodiment, the hook (6) may be comprised of multiple bodies (14) which are coupled to the shelter eye bolt (8) or ring hook. The hook bodies (14) may be flat plates with curved surfaces instead of a curved profile. The pole (3) end surface (11) contains a tapered hole or wedge that receives the hook bodies (14) to assist in coupling the shelter eye bolt (8) or ring hook.

What is claimed is:

1. A system capable of rigidly coupling a device such as a flag pole, camera, sensor, or the like to an eye bolt or hook protruding from a surface.

2. The system of claim 1 that fits in the enclosed collapsed structure of a portable shelter while still coupled to said structure
